(19) United States
(12) Patent Application Publication
(10) Pub. No.: US 2009/0196450 A1
(43) Pub. Date: Aug. 6, 2009

(54) Outdoor High-Fidelity/High Power Audio & Speaker System

(76) Inventor: Jerry Hughes, Plano, TX (US)

Correspondence Address: WILSON DANIEL SWAYZE, JR., 3804 CLEARWATER CT., PLANO, TX, 75025, US

(21) Appl. No.: 12/025,003

(22) Filed: Feb. 2, 2008

(51) Int. Cl. H04R 1/02

(52) U.S. Cl. 381/334

(57) ABSTRACT

A water-resistant and weatherproof high-fidelity/high power audio and speaker system adapted for outside use includes a top speaker member including a first speaker, a bottom speaker member including a second speaker, an audio component member and high current low voltage dc power supply for being mounted under the top speaker member, a spacer member for spacing the top speaker member with the bottom speaker member, and a guide member for cooperating with the spacer member to align the top speaker member and the bottom speaker member. The guide member may be a dowel pin, and the top speaker member may include a speaker terminal member to connect to the first speaker. The top speaker member may include a cabinet handle member to aid in lifting the top speaker member, and the top speaker member may include a tweeter speaker member. The top speaker member may include a woofer speaker member, and the top speaker member may include a base port member for passage of base level sounds.

### FIELD OF THE INVENTION

This invention relates to audio and speaker systems and, more particularly, to a high fidelity/high power audio and speaker system enclosure suitable for permanent installation in an outdoor environment.

### BACKGROUND OF THE INVENTION

Most audio and speaker system assemblies are incapable of extended outdoor use due to the fact they are not designed to withstand the severe conditions experienced in an outdoor environment, namely, from the adverse effects of UV light, extreme temperatures, water, and humidity. In other words, the vast majority of audio systems are not designed to be weatherproof, and can only be used in an outdoor environment on a temporary bases. As such, users are forced to move audio components from interior to exterior to interior locations repeatedly, or rely on other means of remotely transferring audio signals from an indoor to outdoor location, i.e. use of outdoor remote speakers.

While outdoor remote speakers offer a more permanent solution, they have a major drawback in they have to be hardwired or wirelessly connected to interior components, which again, creates an inconvenient arrangement. These outdoor speakers tend to be small lightweight designs to facilitate mounting under eaves of houses or patios, etc, which ultimately results in lower quality audio sound reproduction. Potentially long cable runs required to connect to interior components can also degrade the sound quality.

Outdoor remote speaker assemblies designed specifically to address the negative effects of an exterior environment are not new. Several outdoor designs are currently marketed today, e.g. Pyle® PLMR54, TIC Corporation® GS3, TFS10, ASP120, and Bose® 251, FS51, to name a few.

Patents issued which are representative of currently marketed outdoor speaker assemblies include U.S. Pat. No. 4,754,852 to Mule which discloses a simulated rock speaker cabinet in the form of a natural rock has build-up portions of modeling clay which include a pattern of small diameter holes to form speaker grills at longitudinally spaced positions. A chicken wire ring provides structural reinforcement to the speaker cabinet. The artificial rock cabinet may be molded of various hydrolitic cements, magnesite cement, a suitable catalytic plastic resin to which pigment or other colorants may be added along with glass or rock chips, to provide the simulated rock cabinet with an external appearance which corresponds to various natural rocks. The speaker cabinet has speakers and the various electronic components of the speaker system housed within the speaker cabinet and may be coated with water-proofing and weather-proofing material with the speakers molded into the wells and facing the grills. An end plug may be adhesively sealed to the opening within the base of the speaker cabinet and suitably sealed by Hydrostone or other cementous material.

U.S. Pat. No. 4,574,906 to White discloses a loudspeaker assembly for use outdoors. A woofer speaker is secured in a housing for the downward projection of sound through a generally continuous circumferential aperture between the housing and base. A tweeter is mounted coaxially with the woofer for the projection of sound downwardly thereby providing for the omnidirectional projection of sound from the speaker assembly.

A recent patent application, which discloses an outdoor audio solution, is United States Patent 20070242846 Li, Feng (Hacienda Ht., Calif., US) Cheng, Dennis Hsien Ming (Carson, Calif., US) which discloses an outdoor decorative audio output system includes an outdoor decorative housing and an audio system. The outdoor decorative housing, which is shaped to have an aesthetically natural appeal with weather resistant ability, has an audio cavity, an audio outlet communicating with the audio cavity, and a player compartment for receiving a portable audio player therein. The audio system, which is electrically connected with a power source, includes an audio output receiving in the audio cavity and an audio signal input which is electrically connected to the audio output and is provided at the decorative housing for communicatively connecting the portable audio player, wherein the audio signal input is adapted for receiving an audio signal from the audio player, such that the audio output converts the audio signal into an audible signal to create an optimal environmental audio effect for outdoors.

While the aforementioned speaker assemblies are successful in providing sound reproduction in an outdoor space, current designs do not satisfy all needs

present in the market today. Specifically, the need for indoor quality high-fidelity/high power audio systems designed for permanent outdoor installation and use.

Specific areas lacking in today's outdoor audio and speaker products include:

1) True high-fidelity/audiophile quality audio, i.e. flat frequency response over the entire audible range;

2) Ascetically pleasing cabinetry, i.e. indoor quality and styling;

3) Permanently integrated stereo electronic components;

4) High audio power output, i.e. 50 W plus per channel stereo output;

5) High quality/low noise power supplies, i.e. audio component power supplies capable of maintaining required source voltage ±500 mv at maximum power dissipation;

6) Stand-alone usage, i.e. no hardwired or wireless connections to interior components; and

7) Effective ventilation, i.e. adequate cooling of enclosed active audio components

### SUMMARY

A water resistant speaker system adapted for outside use includes a top speaker member including a first speaker, a bottom speaker member including a second speaker for being mounted under the top speaker member, a spacer member for spacing the top speaker member with the bottom speaker member, and a guide member for cooperating with the spacer member to align the top speaker member and the bottom speaker member.

The guide member may be a dowel pin, and the top speaker member may include a speaker terminal member to connect to the first speaker.

The top speaker member may include a cabinet handle member to aid in lifting the top speaker member, and the top speaker member may include a tweeter speaker member.

The top speaker member may include a woofer speaker member, and the top speaker member may include a base port member for passage of base level sounds.

The bottom speaker member may include a component aperture, and the bottom speaker member may include a component member adapted to fit into the component aperture.

The bottom speaker member may include a component door adapted to cover the component aperture, and bottom speaker member may include a base port member for passage of base level sounds.

The bottom speaker member may include a sub woofer member, and the bottom speaker member may include a grill member to cover the second speaker member.

The bottom speaker member may include a cooling fan member, and the bottom speaker member may include a variable height foot member to adjust the height of the speaker system.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective exterior view of the speaker system of the present invention;

FIG. 2 illustrates a perspective exterior view of the speaker system of the present invention with the component door member being open;

FIG. 3 illustrates alternatives to the active configurations of the present invention;

FIG. 4 illustrates alternatives to the passive configurations of the present invention;

FIG. 5 illustrates an exploded view of the speaker system of the present invention;

FIG. 6 illustrates a perspective wire-frame view of the top speaker member and the bottom speaker member of the present invention;

FIG. 7 illustrates a side wire-frame view of the top speaker member and the bottom speaker member of the present invention;

FIG. 8 illustrates a perspective wire-frame view of the top speaker member and the bottom speaker member of the present invention;

### DETAILED DESCRIPTION

It is the objective of the present invention to offer improvements over the typically available outdoor audio and speaker systems which include:

1) Improved high-fidelity sound:
1a) By increasing cabinet size and including option for additional subwoofer low frequency driver, which results in improved low frequency/base response;
1b) By utilizing highly dense stone veneer for cabinet exterior to minimize enclosure resonance and vibration, which improves overall sound quality by preventing the cabinet from generating extraneous audio waves;
1c) By utilizing bass reflex cabinet design and weatherproof base port tubes to tune low frequency drivers (woofers/subwoofers) to cabinet volume for maximizing low frequency speaker response. Typically used sealed cabinets can not match a reflex design's low frequency response given the use of exact same woofers and cabinet volume;
1d) By optimizing the installed height of the low and high frequency drivers to coincide with listener position ear level for improved stereo imaging;
1e) By using a high current low noise low voltage dc power supply which is highly regulated and maintains required supply voltage at ±500 mv at maximum audio component power dissipation, which ensures sufficient electrical current available for accurate low frequency reproduction, especially at higher listening levels, and ensures noise is not passed from the power supply to the audio components, amplified, and reproduced as audio distortion;
1f) By using high power (50 W/ch plus) audio components, which ensures sufficient audio power available for superior low frequency sound reproduction; and
1g) By reduction and/or elimination of potentially long cable runs, which improve sound quality by reducing wiring resistive, capacitance, and inductive effects.

2) Improved ascetically appealing construction:
2a) By using natural stone veneer, which effectively competes with fine indoor wood cabinetry; and
2b) By duplicating typical indoor styled floor standing cabinets

3) Improved user convenience:
3a) By permanently integrating audio components into the speaker enclosure, so said components do not have to be removed and reinstalled at anytime, which effectively duplicates typical indoor audio arrangements for outdoor use;
3b) By providing elevated mounting location and easily accessible audio components via protective front cover for localized adjustment of all audio selections and parameters, i.e. CD tracks, volume, bass, treble, etc.
3c) By providing integrated lifting handles in the back of the upper speaker cabinets for easy setup and moving of the system;
3d) By modular cabinet design to minimize per unit weight and allow easy setup and relocation; and
3e) By designing multiple configuration options, which allows consumers to select an appropriate configuration to meet their specific needs.

4) Improved user safety:
4a) By utilizing a custom designed low voltage dc power supply that ensures no electrical safety hazards exist, which is important in a potentially wet outdoor environment; and
4b) By utilizing non-flammable and non-conductive construction materials for the enclosure, which houses all electrical and heat generating components.

5) Improved audio component reliability:
5a) By utilizing filtered forced air ventilation for component cooling, which will prevent overheating and extend the life span; and
5b) By selecting and using marine grade audio components; which are designed specifically for use in an outdoor/wet environment.

6) Improved enclosure weather durability:
6a) By utilizing natural stone veneer, which, when properly prepared, provides superior life expectancy over many other materials.

The present invention is a high fidelity stereo audio outdoor speaker system with optional integrated low-voltage/high-power CD/AM/FM/MP3 Player audio electronics. It includes natural polished stone veneer, which should be weatherproof, i.e. rain, snow, hail, wind, etc. The stone veneer cabinet design has very low cabinet resonance/vibration due to the density of the natural stone and provides improved sound reproduction, especially at the higher listening levels.

In addition, the present invention provides modular cabinet design which allows multiple configurations options to be offered to the consumer, while maintaining manufacturing standardization and reducing cost.

The primary market is for outdoor/weatherproof high-fidelity stereo audio. The speaker system of the present invention is a high fidelity audio product that can withstand the environmental abuse from extended outdoor use and at the same time offer the attractiveness and convenience of an indoor product.

The secondary market for the present invention will include indoor high fidelity stereo audio due the attractiveness of the polished stone and low cabinet resonance/vibrations, which provides improved sound reproduction.

The present invention uses non-corrosive hardware, and no materials should be used in the fabrication that would be susceptible to corrosion, mold, mildew or rot. The base-reflex cabinet uses a weatherproof port design. The modular cabinets aid in keeping the weight of the speaker-audio unit as low as possible, but sufficiently heavy to withstand normal outdoor wind conditions and storms. The integrated handle in the back of each upper speaker unit allows for easy lifting, assembly, and moving. The lower audio electronic cabinet is designed to include forced air ventilation for maximum cooling and life of the enclosed marine grade audio components.

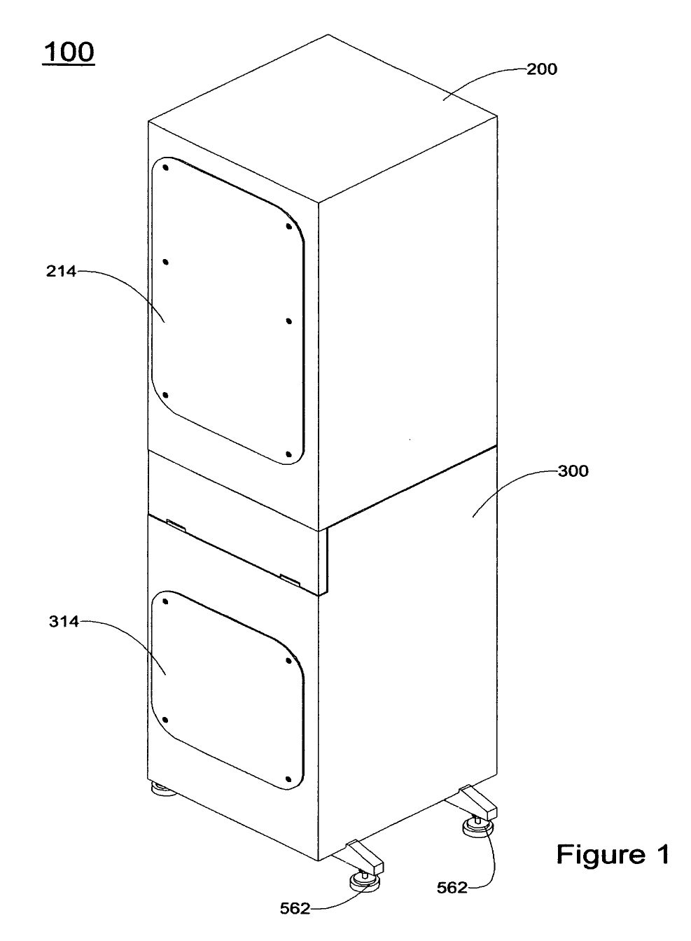

FIG. 1 illustrates a perspective view of speaker system 100 in accordance with the present invention. The speaker system 100 may include an outside shell or outer housing which is weatherproof and may be decorated with stone, concrete, brick, plastic, or any other appropriate waterproof decoration. The speaker system 100 includes a top speaker member 200 and a bottom speaker member 300.

Additionally, FIG. 1 illustrates the grill member 214 to protect the speakers for these top speaker member 200 and a grill member 314 to protect the speakers form the bottom speaker member 300. FIG. 1 additionally illustrates the variable height foot member 562 which allows the speaker system 100 to be adjusted and leveled.

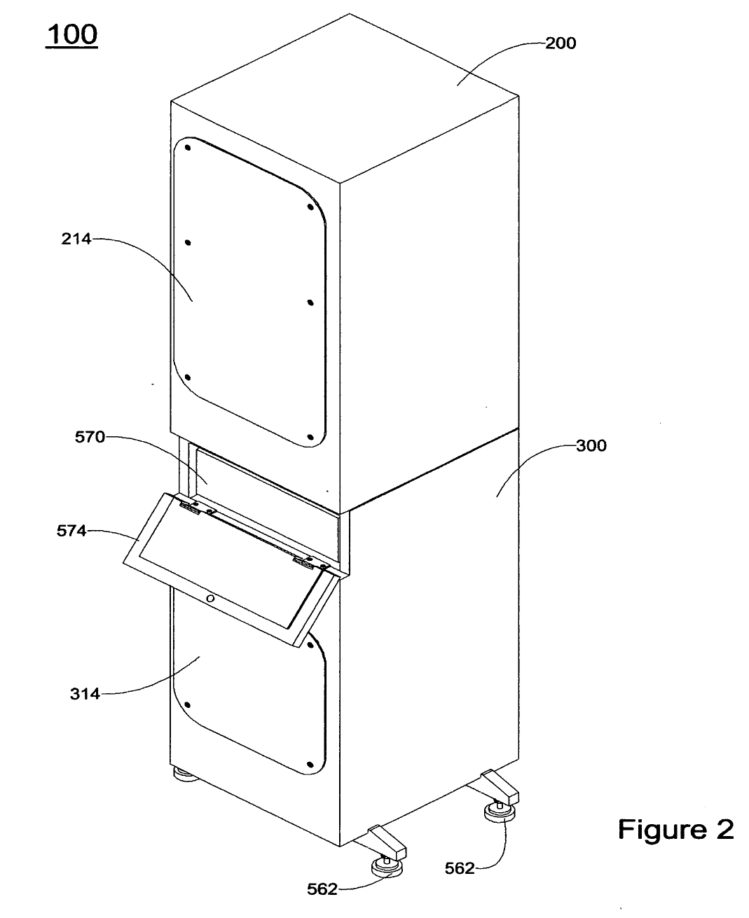

FIG. 2 illustrates a perspective view of the top speaker member 200 and the bottom speaker member 300. Additionally, FIG. 2 illustrates the grill member 214 to protect the speakers for these top speaker member 200 and a grill member 314 to protect the speakers for the bottom speaker member 300. FIG. 2 additionally illustrates the variable height foot member 562 which allows the speaker system 100 to be adjusted and leveled. FIG. 2 additionally illustrates a component door member 574 which allows access to the component aperture 570 to access the component member 572

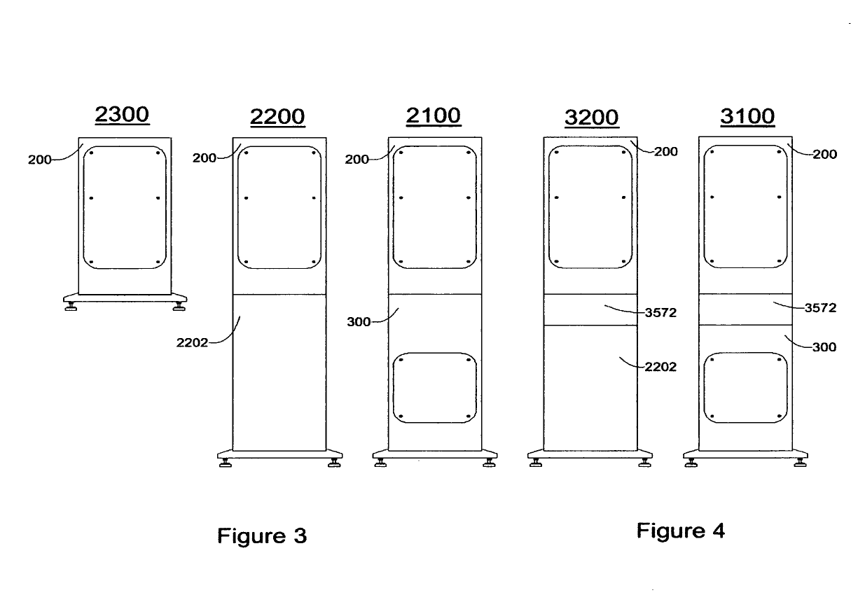

FIG. 3 illustrates a configuration for a passive speaker arrangement which include a first speaker element 2100 which includes the top speaker member 200 and the bottom speaker member 300, a second speaker element 2200 which may include only the top speaker member 200 positioned on a base member 2202 without a speaker and the third speaker element 2300 which may include only the top speaker member 200.

FIG. 4 illustrates a configuration for an active speaker arrangement which includes a first active speaker element 3100 which includes the top speaker member 200 and the bottom speaker member 300. The first active speaker element 3100 additionally includes an active component member 3572 which may be a CD player, a radio a disk drive or other active element to produce sounds for the speakers.

FIG. 3 additionally illustrates a second active speaker element 3200 which may include a top speaker member 200 positioned on a base member 2202 without speaker. The second active speaker element 3200 includes the active component member 3572.

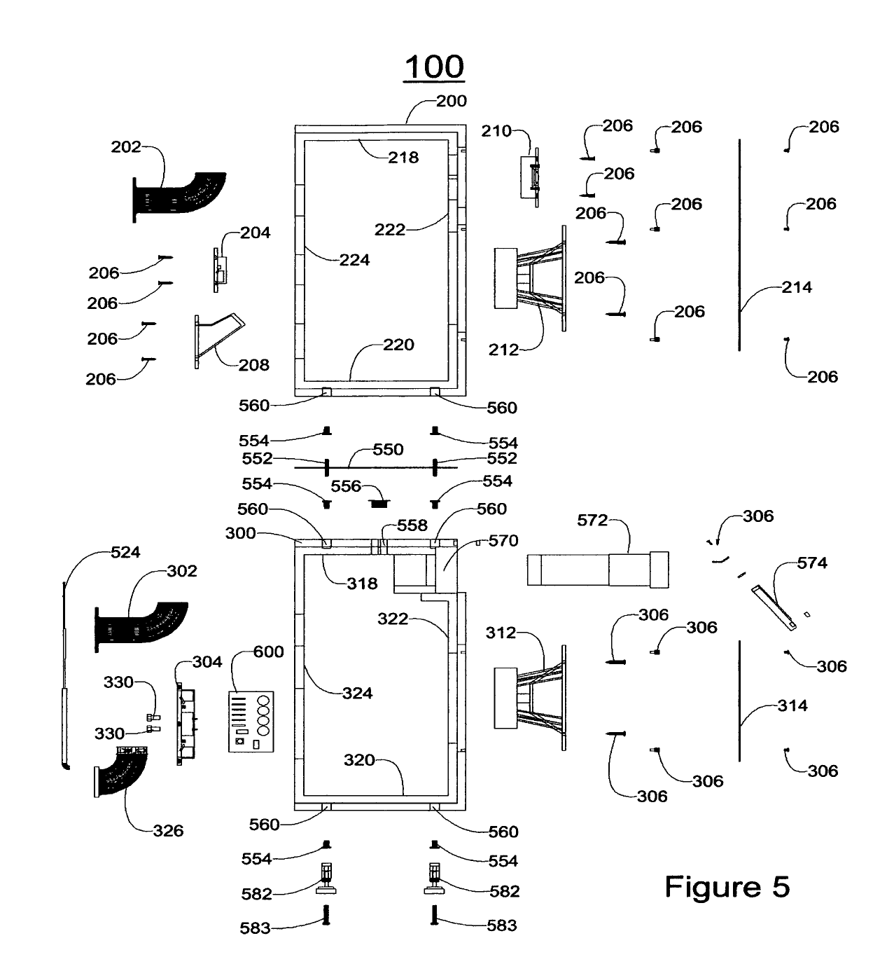

FIG. 5 illustrates an exploded view of speaker system 100 in accordance with the present invention. The top speaker member 200 includes a housing member, which includes a top member 218, a bottom member 220, a front member 222 and a back member 224, and a pair of opposing side members 226 (not shown). The speaker system 100 includes a base port member 202 for transmitting base level sounds and a speaker terminal member 204 to connect to the speakers. The base port member 202 extends into the cavity of the housing member and may include a portion which curves upwards. The speaker system 100 includes fastener member 206 which may be screws or other fastening devices for connecting various elements of the speaker system 100 together. The speaker terminal member 204 is positioned in the back member 224, and a cabinet handle member 208 is positioned in the back member 224 to aid in the lifting the speaker system 100. Additionally, the end of the base port member 202 is positioned in the back member 224 and extends into the cavity of the housing member.

Additionally, the speaker system 100 includes a tweeter speaker member 210 and a woofer speaker member 212, and the tweeter speaker member 210 and the woofer speaker member 212 are formed in the front member 222. The tweeter speaker member 210 and the woofer speaker member 212 may be covered by a grill member 214 to protect the speakers 210, 212. The bottom member 220 includes positioning apertures 560 to cooperate with guide members 552 which may be a dowel pin to position the top speaker member 200 with the bottom speaker member 300.

FIG. 5 additionally illustrates that the speaker system 100 includes a bottom speaker member 300 which may include similar elements as found in the top speaker member 200 and which includes a base port member 302 for passing the base level sounds, and the base port member 302 extends into the bottom speaker member 300 and may include a curved extending portion. The bottom speaker member 300 includes a speaker terminal member 304 to connect the sub-woofer speaker member 312 which may be a sub woofer speaker or any other type of speaker. The bottom speaker member 300 includes a cooling fan assembly to provide forced air ventilation for the enclosed air space. The bottom speaker member 300 includes fastener member 306 for fastening various elements to the bottom speaker member 300. The bottom speaker member 300 includes a top member 318, a bottom member 320 a front member 322, a back member 324, and opposing side members 326. The top member 318 includes a positioning aperture 560 to cooperate with the guide member 552, and as a consequence, the bottom speaker member 300 is substantially aligned with the top speaker member 200.

Additionally, the bottom speaker member 300 may include apertures 558 for access to the component member 572 and plug members 556 for preventing water ingress. The front member 322 accepts the sub woofer member 312 and may be covered with a grill member 314 to protect the sub woofer member 312. The bottom member 320 may include a positioning aperture 560 to cooperate with the bushing member 554 which cooperates with the variable height foot member 562 and fastener members 583 which is adapted to raise and lower the bottom speaker member 300 in order to level the bottom speaker member 300 The front member 322 includes a component aperture 570 to cooperate with a component door member 574 and a component member 572 which may be audio or video equipment such as a CD player, radio tape deck or other electronic device which may be electrically connected to a high current low voltage dc power supply member 600 which may be electrically connected to electrical connector member 330 for connection to a suitable low voltage ac electrical power source. The component member 572 may be connected to the tweeter speaker member 210, the woofer speaker member 212 and the sub woofer speaker member 312. An antenna member 524 may be affixed to the back member 324 for reception of the component member 572.

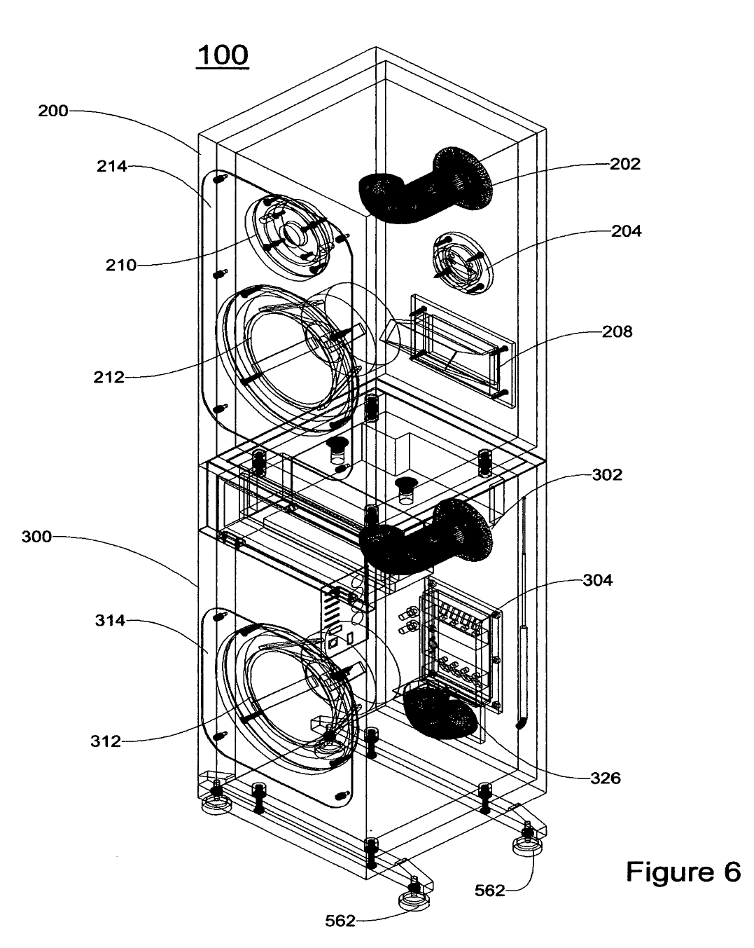

FIG. 6 illustrates a top speaker member 200 which includes the base port member 202 for passing base level sounds, the speaker terminal member 204 to connect to the speakers, the cabinet handle member 208 to assist the user in moving the top speaker member 200. FIG. 6 additionally illustrates the tweeter speaker member 210 and the woofer speaker member 212 which is protected by the grill member 214. FIG. 6 illustrates the bottom speaker member 300 which includes the base port member 302, the speaker terminal member 304 to connect to the speaker, the cooling fan assembly member 326 which provides cabinet ventilation, and the sub woofer speaker member 312 which is protected by the grill member 314. FIG. 6 additionally illustrates the variable height foot member 562 to adjust the height of the speaker system 100.

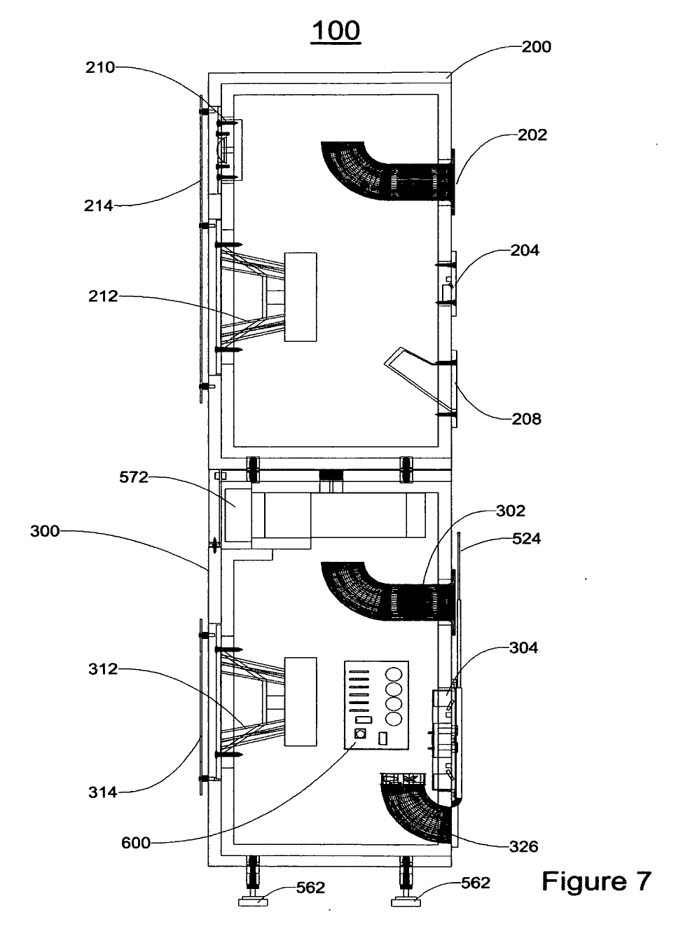

FIG. 7 illustrates a top speaker member 200 which includes the base port member 202 for passing base level sounds, the speaker terminal member 204 to connect to the speakers, the cabinet handle member 208 to assist the user in moving the top speaker member 200. FIG. 7 additionally illustrates the tweeter speaker member 210 and the woofer speaker member 212 which is protected by the grill member 214. FIG. 7 illustrates the bottom speaker member 300 which includes the base port member 302, the speaker terminal member 304 to connect to the speaker, the sub woofer speaker member 312 which is protected by the grill member 314, and cooling fan assembly member 326 which provides cabinet ventilation. FIG. 7 additionally illustrates the antenna member 524, for receiving radio signals, and a high current low voltage dc power supply member 600 which connects to the audio component member 572, and a variable height foot member 562 to adjust the height of the speaker system 100.

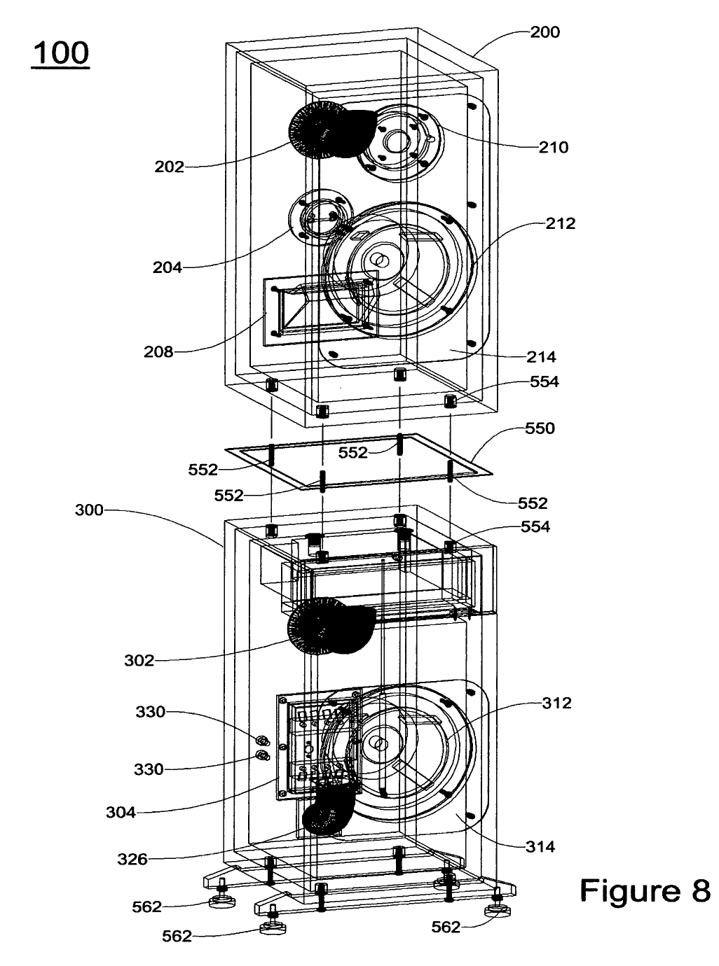

FIG. 8 illustrates a top speaker member 200 which includes the base port member 202 for passing base level sounds, the speaker terminal member 204 to connect to the speakers, the cabinet handle member 208 to assist the user in moving the top speaker member 200. FIG. 8 additionally illustrates the tweeter speaker member 210 and the woofer speaker member 212 which is protected by the grill member 214. FIG. 8 illustrates the bottom speaker member 300 which includes the base port member 302, the speaker terminal member 304 to connect to the speaker, the sub woofer speaker member 312 which is protected by the grill member 314, cooling fan assembly member 326 which provides cabinet ventilation, and electrical connector member 330 for connection to a suitable external low voltage ac electrical power source and high current low voltage dc power supply. FIG. 8 additionally illustrates the variable height foot member 562 to adjust the height of the speaker, and the spacer member 550 to cooperate with the top speaker member 200 and the bottom speaker member 300. The spacer member 550 is positioned by guide members 552 which cooperate with bushing member 554 positioned in the top speaker member 200 and the bottom speaker member 300.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A water resistant speaker system adapted for outside use, comprising:
a top speaker member including a first speaker;
a bottom speaker member including a second speaker for being mounted under the top speaker member:
a spacer member for spacing the top speaker member with the bottom speaker member:
a guide member for cooperating with the spacer member to align the top speaker member and the bottom speaker member.

2) A water resistant speaker system adapted for outside use as in claim 1, wherein the guide member is a dowel pin.

3) A water resistant speaker system adapted for outside use as in claim 1, wherein the top speaker member includes a speaker terminal member to connect to the first speaker.

4) A water resistant speaker system adapted for outside use as in claim 1, wherein the top speaker member includes a cabinet handle member to aid in lifting the top speaker member.

5) A water resistant speaker system adapted for outside use as in claim 1, wherein the top speaker member includes a tweeter speaker member.

6) A water resistant speaker system adapted for outside use as in claim 1, wherein he top speaker member includes a woofer speaker member.

7) A water resistant speaker system adapted for outside use as in claim 1, wherein the top speaker member includes a base port member for passage of base level sounds.

8) A water resistant speaker system adapted for outside use as in claim 1, wherein the bottom speaker member includes a component aperture.

9) A water resistant speaker system adapted for outside use as in claim 8, wherein the bottom speaker member includes a component member adapted to fit into the component aperture.

10) A water resistant speaker system adapted for outside use as in claim 8, wherein he bottom speaker member includes a component door adapted to cover the component aperture.

11) A water resistant speaker system adapted for outside use as in claim 1, wherein the bottom speaker member includes a base port member for passage of base level sounds.

12) A water resistant speaker system adapted for outside use as in claim 1, wherein the bottom speaker member includes a sub woofer member.

13) A water resistant speaker system adapted for outside use as in claim 1, wherein the bottom speaker member includes a grill member to cover the second speaker member.

14) A water resistant speaker system adapted for outside use as in claim 1, wherein the bottom speaker member includes a cooling fan member.

15) A water resistant speaker system adapted for outside use as in claim 1, wherein the bottom speaker member includes a variable height foot member to adjust the height of the speaker system.

16) A water resistant speaker system adapted for outside use as in claim 1, wherein the bottom speaker member includes a high current low voltage dc power supply for powering the audio component member
